(19) United States
(12) Patent Application Publication
(10) Pub. No.: US 2023/0376654 A1
(43) Pub. Date: Nov. 23, 2023

(54) PIPELINE VECTORIZATION METHOD TO PREDICT INTERNAL CORROSION

(71) Applicant: Saudi Arabian Oil Company, Dhahran (SA)

(72) Inventors: Meshal K. Alarfaj, Dhahran (SA); Yousef A. Al-Rowaished, Abqaiq (SA); Faisal M. Al-Abbas, Dammam (SA); Avidipto Biswas, Paris (FR); Christian Canto Maya, Dhahran (SA); Tarik M. Al-Hoshan, Dhahran (SA)

(21) Appl. No.: 17/750,757

(22) Filed: May 23, 2022

(51) Int. Cl. G06F 30/28

(52) U.S. Cl. CPC G06F 30/28

(57) ABSTRACT

A method for predicting locations at risk of internal corrosion is provided. The method includes performing a pipeline condition simulation that includes segmenting a flow line into segment based, at least in part, on pipeline attributes, running a hydraulics model to calculate flow parameters along the pipeline, and modeling corrosion rate based, at least in part, on results from the hydraulics model. Segments along the pipeline that are at risk of internal corrosion are identified.

### TECHNICAL FIELD

The present disclosure is directed to a method for predicting locations susceptible to internal corrosion in pipelines.

### BACKGROUND

The production of crude oil and natural gas often uses gathering lines that convey the oil and gas from wellheads to central locations for processing. These lines are generally short, for example, often less than a few miles in length. Further, the gathering lines may have numerous tie-ins from other lines, and significant elevation changes. As a result, the lines are difficult, if not impossible, to inspect using remote sensing devices, such as inspection pigs. As the lines are usually buried, visual and instrumental inspections from external surfaces is difficult.

### SUMMARY

An embodiment described in examples herein provides a method for predicting locations at risk of internal corrosion. The method includes performing a pipeline condition simulation that includes segmenting a flow line into segment based, at least in part, on pipeline attributes, running a hydraulics model to calculate flow parameters along the pipeline, and modeling corrosion rate based, at least in part, on results from the hydraulics model. Segments along the pipeline that are at risk of internal corrosion are identified.

### BRIEF DESCRIPTION OF DRAWINGS

FIG. 1 is a drawing of a gathering system in a hydrocarbon field, showing lines that cannot be inspected by remote sensing devices.

FIG. 2 is a schematic drawing of the segmentation of a pipeline based on pipeline attributes like pipeline joint identifications, wall thickness (WT), inclination angle, and pipeline length (1), among others.

FIG. 3 is a process flow diagram of a method for the dynamic segmentation of a pipeline based on pipeline attributes like wall thickness (WT), inclination angle, and pipeline length (1).

FIG. 4 is drawing of data management for generating time series arrays.

FIG. 5 is an example of a pipeline hydraulics and corrosion simulation module, used to develop the pipeline attribute tensor.

FIG. 6 is a process flow diagram of a method for modeling corrosion in a pipeline.

### DETAILED DESCRIPTION

A method is provide to enhance the reliability of pipelines, and to improve sustainability by identifying locations that are spatially and dynamically susceptible to internal corrosion or erosion. The method is based on a spatial and dynamic vectorization along the line over the timeframe where data is available. The spatial segmentation considers the pipeline segment size and the pipeline physical variables that affect the flow velocity of the stream. The dynamic segmentation iterates the segment calculation over the data availability timeframe.

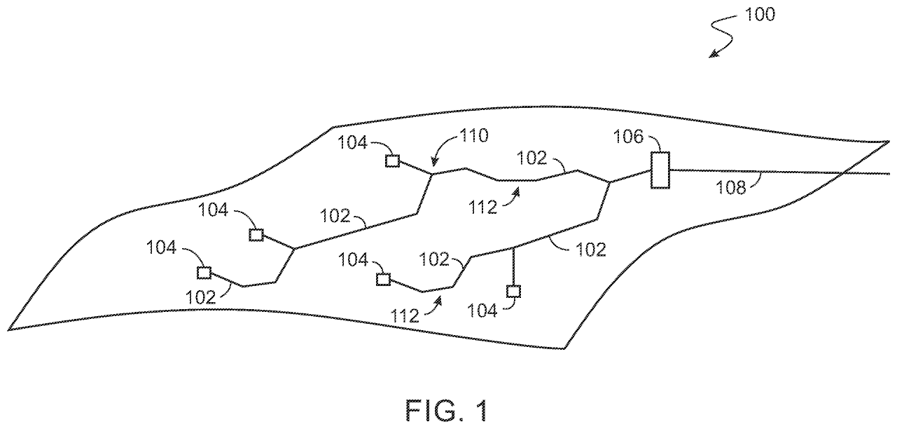

FIG. 1 is a drawing of a gathering system in a hydrocarbon field 100, showing lines that cannot be inspected by remote sensing devices. Upstream flow lines 102 gather the multiphase flow from the production wells 104 to downstream processing units, such as oil separation tanks 106, from which a larger pipeline 108 may carry separated oil to other facilities.

The upstream flow lines 102 are generally buried, and have numerous direction, elevation, and segmentation changes. For example, a tie-in 110 is used to connect upstream flow lines 102 from different production wells 104. The flow line after the tie-in 110 may be larger as a larger amount of the multiphase flow will be present. Some segments 112 of the upstream flow lines 102 will be at different elevations, for example, as the upstream flow lines 102 will follow the topography from the production wells 104 to the oil separation tanks 106.

The multiphase flow can include water and corrosive materials, such as CO₂ and H₂S, which can lead to internal corrosion of the upstream flow lines 102. Segments at lower elevations may have increased water contact from settling, resulting in an increased tendency towards corrosion. Many vintage pipeline or gathering line systems were not constructed with maintenance and inspection programs in mind. Thus, identifying internal localized corrosion of the upstream flow lines 102 may be challenging. Further, hydrocarbon fields are often at locations far from any high consequence area, leaving the inspection and mitigation programs hard to design and execute for gathering networks.

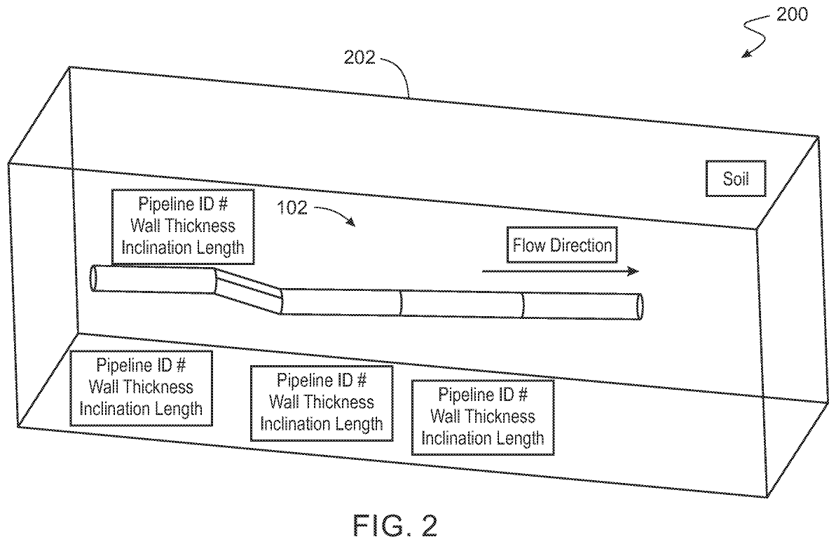

FIG. 2 is a schematic drawing 200 of the segmentation of a pipeline 102 based on pipeline attributes like pipeline joint identifications, wall thickness (WT), inclination angle, and pipeline length (1), among others. Like numbered items are as described with respect to FIG. 1. The flow lines are typically constructed by welding multiple segments, usually of the same diameter and length. The schematic drawing 200 represents the initial spatial segmentation, for example, from design documents. As the data is available, a dynamic iteration, or dynamic segmentation, is performed to generate a vector for each segment, resulting in a matrix for the pipeline.

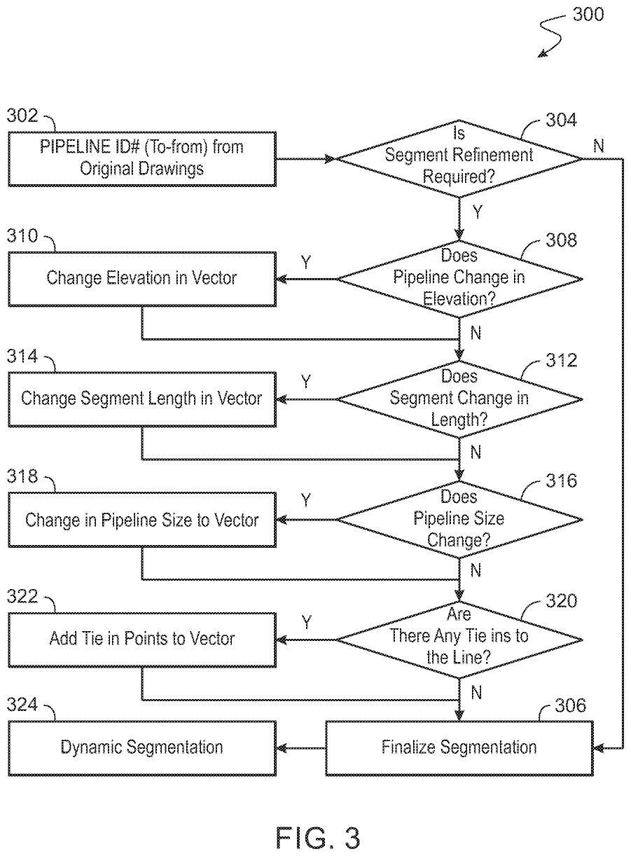

FIG. 3 is a process flow diagram of a method 300 for the dynamic segmentation of a pipeline based on pipeline attributes like wall thickness (WT), inclination angle, and pipeline length (1). The dynamic segmentation is the initial stage of the segmentation process. In this initial stage, two steps are considered based on the physical characteristics of the flow line, for example, as the joint segment length and pipeline attributes changes.

The method 300 begins with the initial pipeline segment identification from the original drawings, or as built information. This is used to provide an initial segmentation, for example, creating a vector for each pipe segment or pipe joint. At block 304, a determination is made by checking an attribute called “Repair” if there is a repair that took place in this segment it will have value 1 if not then it is zero as to whether segment refinement is required. If not, process flow proceeds to block 306 to finalize the segmentation, for example, determine that all variables associated with the physical characteristics of the pipe, like elevation, size, diameter, and the like, have been verified and recorded.

If segment refinement is required at block 304, process flow proceeds to block 308. At block 308, a determination is made as to whether the pipeline, for example, a joint or segment, changes in elevation. If so, at block 310 the elevation change is recorded in the vector.

At block 312, a determination is made as to whether a joint or segment changes in length. If so, at block 314, the segment length is recorded in the vector.

At block 316, a determination is made as to whether a joint or segment changes in size, such as diameter. If so, at block 318, the segment diameter is recorded in the vector.

At block 320, a determination is made as to whether a joint or segment has a tie in. If so, at block 322, the segment diameter is recorded in the vector.

If at block 306, a determination is made that segmentation is finished, for example, if process flow came from blocks 320 or 322, that all segments have been processed. If process flow came from block 304, the determination may be that no changes have been made to the system since the initial construction, and, thus that the vectors comprise an accurate data set.

After the physical segmentation ends at block 306, a dynamic segmentation 324 incorporates other attributes into the vectors, such as pipeline age, pipeline production history, and geochemical analysis obtained from records. For example, production data and chemical reports change over time, along every single segment along the pipeline. Taking the latest information, the vector for every single segment, all the segments will create the matrix at one single time snap. Over the years, a tensor that includes all of the historical records of the segments is created. If current data is not available, the latest version of the information is utilized.

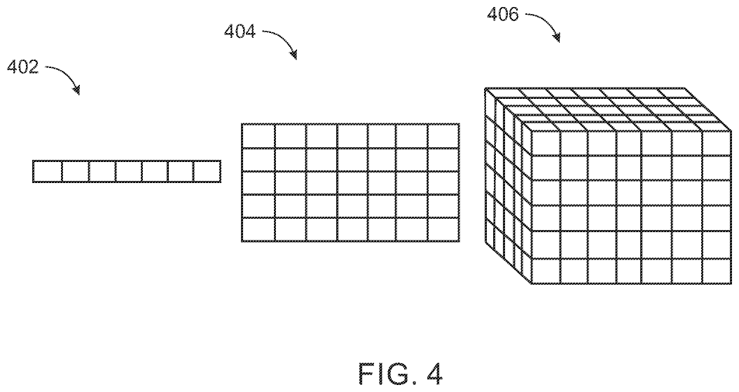

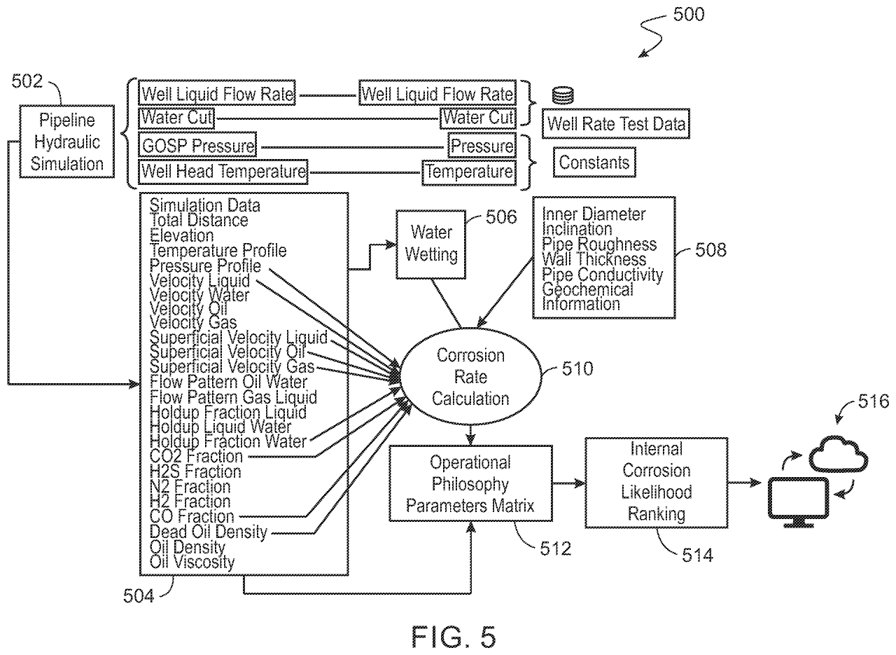

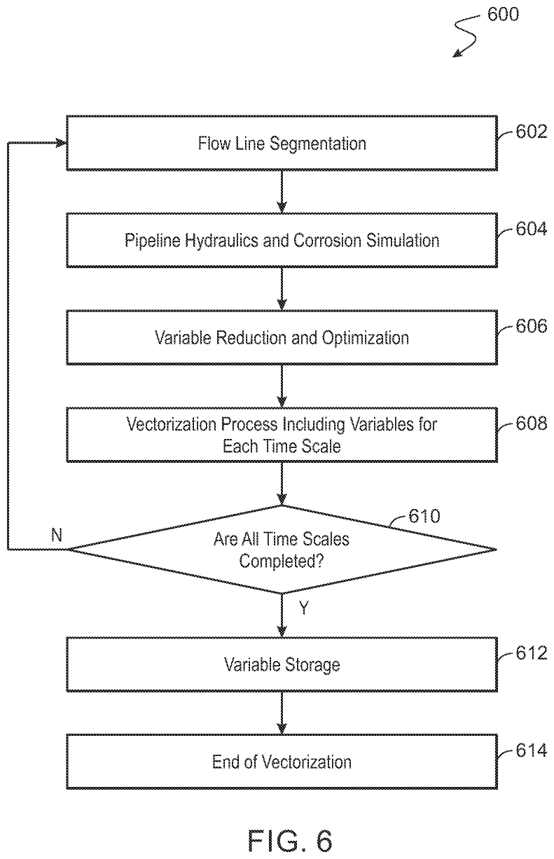

FIG. 4 is drawing of data management for generating time series arrays. The data for each segment creates a vector 402, while the full set of data for the pipeline network creates a matrix 404. Using the techniques described with respect to FIGS. 5 and 6, each data set is computed over the pipeline operation interval, representing a time scale for the further analysis, for example, a monthly time scale, creating a tensor 406 representing the static and dynamic properties of the pipeline network.

The generated and computed variables, such as velocity, flow rate, and the like, are combined with the time scale to produce a valid correlation related to pipeline degradation to generate a variable vector. The variable vector developed during the segmentation process creates the matrix of attributes, which computed over the time series forms the pipeline attribute tensor 406, as illustrated in FIG. 4.

FIG. 5 is an example of a pipeline hydraulics and corrosion simulation module 500, used to develop the pipeline attribute tensor 406. The module 500 can be used A hydraulics simulation 502 is run for the system, adding data such as flow rate, holdup fractions, and liquid velocity, among others, to a data set 504 that includes composition information, such as CO₂ and H₂S fraction.

The information from the data set 504 is used to determine the water wetting 506 of the pipeline, such as the water wetting of each pipeline segment. The water wetting 506 and descriptive information 508 on the pipeline segment, such as inner diameter, inclination, surface roughness, and the like, is used in a corrosion rate calculation 510. The corrosion rate calculation 510 can be performed by a commercial software package or by an open source software, such as, Multicorp available as an open source package from the Ohio University. Multicorp is an internal corrosion model that is based on a mechanistic process where CO₂/H₂S and hydraulics are considered in the calculation.

The output of the corrosion rate calculation 510 is combined with a matrix of parameters 512 determined by operating philosophies, such as maintenance cleaning frequencies, corrosion inhibition treatment, shut in periods, shut in processes, and the like. These may be determined by information from subject matter experts (SME), such as information from the National Association of Corrosion Engineers (NACE), and other standards. The matrix of parameters 512 may be used to increase or decrease the values from the corrosion rate calculation 510. For example, the operating factors may change the typical corrosion mechanism or the water holdup and accumulation. These changes may impact the corrosion rate in particular segments of the pipeline network.

The results of the corrosion rate calculation 510 as modified by the matrix of parameters 512 are used to determine a probability ranking 514 of the likelihood of internal corrosion. Each variable identified with impacting the corrosion degradation is further adjusted to include a class value. The class identifier follows the SME opinion and scientific knowledge to create the probability ranking 514 based on its corrosion effect.

The ranking 514 classifies the operating parameters to infer the integrity condition of the pipeline, such as segments that are likely to be most prone to internal corrosion. The output 516 of the module 500 allows the selection of pipeline segments for further calculations or physical inspections, such as by excavating around individual pipe segments to measure internal corrosion by physical techniques, such as ultrasonic imaging and the like.

FIG. 6 is a process flow diagram of a method 600 for modeling corrosion in a pipeline. The method 600 begins at block 602 with the flow line segmentation, for example, as described with respect to FIG. 4. At block 604, the pipeline hydraulics and corrosion simulation is performed. This is performed by the module described with respect to FIG. 5, which illustrates the simulation process to generate, store and create extra variables to be utilized in the attribute tensor. As described with respect to FIG. 5, the simulation process starts with the pipeline hydraulic simulation, which incorporates flow characteristics, pipeline attributes, and the physical and chemical features of the stream. All these variables were processed through a mechanistic model to create the required inputs to calculate the water wetting condition along the pipeline. The geochemical information is added as an input along with water wetting conditions to produce the general corrosion rate and scale tendency, used to determine localized corrosion likelihood.

At block 606, variable reduction and optimization is performed. All these calculations are stored as data inputs for further optimization. An optimization stage adjusts the variables to include only those that affect corrosion degradation and do not have interdependencies in the intermediate calculations.

At block 608, a vectorization process is performed including variables for each time scale which is done by retrieving the pipeline information from the database then classifying the data, such as pressure, temperature, velocity, and the like, into different level of ranges based on standards and experts knowledge. After that, each data point will be transformed into a vector of attributes that have direct impact to the internal corrosion. Each data point, or vector, represents a scenario of how the different attributes are acting together and affecting the rate of the corrosion.

At block 610, a determination is made as to whether all time scales have been completed. The time scales are selected based on production changes, but a time scale may be selected by operational parameters. For example, a typical evaluation of production may happen on a quarterly basis. If not, process flow returns to block 602 to continue it the next time scale.

At block 612, the variables from the calculation are stored. For example, the variables may be transferred to a network for further calculation and display.

At block 614, the vectorization is ended. At this point, the results may be presented to a user. Further, other probabilistic algorithm models may applied on the vectorization results for prediction purposes but it is not claimed here as part of this invention.

### Embodiments

An embodiment described in examples herein provides a method for predicting locations at risk of internal corrosion. The method includes performing a pipeline condition simulation that includes segmenting a flow line into segment based, at least in part, on pipeline attributes, running a hydraulics model to calculate flow parameters along the pipeline, and modeling corrosion rate based, at least in part, on results from the hydraulics model. Segments along the pipeline that are at risk of internal corrosion are identified.

In an aspect, segmenting the flow line includes performing a spatial segmentation and performing a dynamic segmentation. Performing the spatial segmentation includes creating a vector for each segment that includes pipe identification, segment length, elevation changes, or size, or any combinations thereof.

In an aspect, running the hydraulics model includes determining water wetting conditions for each segment.

In an aspect, modeling the corrosion rate includes entering the water wetting conditions into a corrosion rate calculation, entering pipe characteristics into the corrosion rate calculation, and generating a corrosion rate for each segment. In an aspect, operational philosophy parameters are combined with the corrosion rate for each segment to generate an internal corrosion likelihood ranking. In an aspect, identifying segments is based, at least in part, on the internal corrosion likelihood ranking.

In an aspect, the method includes reducing variables to eliminate variables that do not affect the identification of segments. In an aspect, the method includes optimization of the pipeline condition simulation. In an aspect, the method includes performing a vectorization of variables. In an aspect, a matrix of vectors is formed to represent the pipeline.

In an aspect, the pipeline condition simulation is iterated across multiple time scales. In an aspect, a tensor of the time scale data is formed across the segments of the pipeline. In an aspect, a risk ranking is performed on the segments.

Other implementations are also within the scope of the following claims.

What is claimed is:

1. A method for predicting locations at risk of internal corrosion, comprising performing a pipeline condition simulation comprising:
segmenting a flow line into segment based, at least in part, on pipeline attributes;
running a hydraulics model to calculate flow parameters along the pipeline;
modeling corrosion rate based, at least in part, on results from the hydraulics model; and
identifying segments along the pipeline that are at risk of internal corrosion.

2. The method of claim 1, wherein segmenting the flow line comprises:
performing a spatial segmentation; and
performing a dynamic segmentation.

3. The method of claim 1, wherein performing the spatial segmentation comprises creating a vector for each segment that comprises pipe identification, segment length, elevation changes, or size, or any combinations thereof.

4. The method of claim 1, wherein running the hydraulics model comprises determining water wetting conditions for each segment.

5. The method of claim 4, wherein modeling the corrosion rate comprises:
entering the water wetting conditions into a corrosion rate calculation;
entering pipe characteristics into the corrosion rate calculation; and
generating a corrosion rate for each segment.

6. The method of claim 5, comprising combining operational philosophy parameters with the corrosion rate for each segment to generate an internal corrosion likelihood ranking.

7. The method of claim 6, wherein identifying segments is based, at least in part, on the internal corrosion likelihood ranking.

8. The method of claim 1, comprising reducing variables to eliminate variables that do not affect the identification of segments.

9. The method of claim 1, comprising optimization of the pipeline condition simulation.

10. The method of claim 1, comprising performing a vectorization of variables.

11. The method of claim 10, comprising forming a matrix of vectors to represent the pipeline.

12. The method of claim 1, comprising iterating the pipeline condition simulation across multiple time scales.

13. The method of claim 12, comprising forming a tensor of the time scale data across the segments of the pipeline.

14. The method of claim 1, comprising performing a risk ranking on the segments.
